(19) United States
(12) Patent Application Publication
(10) Pub. No.: US 2010/0211863 A1
(43) Pub. Date: Aug. 19, 2010

(54) ACTION-BASED PRE-POPULATION OF USER PROFILES

(75) Inventors: Katherine Jones, Seattle, WA (US); Christopher Parker, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/389,303

(22) Filed: Feb. 19, 2009

(51) Int. Cl. G06F 17/20

(52) U.S. Cl. 715/224

(57) ABSTRACT

Usage data representing users' actions with applications, client devices such as PCs, and peripheral devices like personal media players is collected from a variety of sources and utilized by an automated user profile population service to pre-populate user profile forms with suggestions for entries that can be presented to an application user when initially registering with the application or when a user profile gets updated. The user can review the suggested pre-populated entries in the user profile form and accept those that are appropriate and desired and reject those that are not.

### BACKGROUND

The widespread availability of Internet connectivity has helped to foster the creation of a diverse set of on-line applications that support various kinds of user experiences, services, and transactions on a PC (personal computer) or other device. Such applications may include, for example, social networking, communication such as e-mail and instant messaging, e-commerce, news and information, games and entertainment, banking and other financial transactions, media sharing (such as video, audio, or photo sharing), topical forums, and many other types of websites.

In order to enable user interaction with some applications, enhance application functionality, or improve the user experience, application users may be asked to complete a user profile. This could occur, for example, when the user first signs up or registers to use an application. User profiles can include various types of data—such as demographic information, interests, hobbies, likes/dislikes, education, job/profession, and other expressions of taste, beliefs, personality, or identity, etc.,—and be employed in different ways by different applications. For example, a user profile can be internally used by an e-commerce application, such as an on-line bookstore, to enable the user to express reading preferences. The application can use the profile when making book recommendations whenever the user visits the bookstore's website. In other scenarios, such as social networking, the user profile provides an on-line representation of the user's identity and personality and may include quite a bit of information to facilitate wide ranging and/or close relationships with other social network users, or web-users in general.

The accuracy and completeness of the user profile will typically affect the quality of the user experience. As a result, the forms that users fill out to generate their profiles can often be fairly comprehensive. Users may find filling out the forms to be time consuming and burdensome. In cases where a user signs up with multiple applications, for example by registering with a number of social networking application providers, the effort to create the profiles can become particularly repetitious and tedious. In addition, profiles often need to be updated in order to keep information current and accurate. This need can compound the time and efforts required for users to effectively maintain their profiles and on-line identities.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Usage data representing users' actions with applications, client devices such as PCs, and peripheral devices like personal media players is collected from a variety of sources and utilized by an automated user profile population service to pre-populate user profile forms with suggestions for entries that can be presented to an application user when initially registering with the application or when a user profile gets updated. The user can review the suggested pre-populated entries in the user profile form and accept those that are appropriate and desired and reject those that are not.

The suggested entries for pre-population in the profile form may be generated by collecting usage data from individual application users as well as by aggregating usage data from multiple users. The usage data will typically be collected transparently but only upon notice to the user and with the user's consent. The usage data will typically be indicative of user behavior, intent, interests, attitudes, and preferences, among other characteristics. When aggregated, the usage data can be correlated across the multiple users and utilized as a source of statistically significant information for predicting user characteristics and tendencies.

In an illustrative example involving social networking, suggestions can be made for pre-populated user profile entries dealing with music by collecting data about individual usage of music and other applications. The collected usage data might include songs and/or artists that the user has listened to most often, listened to recently, recommended to others, and the like. The user profile population service could then pre-populate the user profile form, for example with several of the most frequently played artists as suggestions for favorite music that the user might wish to include in his or her user profile.

Aggregated usage data can also be used to make suggestions for pre-populated entries in the user profile form. Such suggestions can be made within the same profile category (e.g., music) or across categories (e.g., books, movies, television, etc.). For example, when the user's individual usage data is compared with the aggregated usage data, the results might indicate that the user would tend to like a particular artist, book, program, or movie, etc. because other people who have similar tastes and interests as the user also like such things.

Individual and aggregated usage data can also be used to pre-populate suggestions when user profiles get updated. User profiles can often need updating due to the dynamic nature of many on-line application environments and changing user tastes and preferences. The individual usage data could indicate, for example, that a user has developed a new taste for a particular genre of entertainment, changed jobs, or has acquired a new hobby. Rather than require the user to manually update the user profile, the user profile service can notify the user that an update could be made and make suggestions as to entries in the profile that may be updated.

The present arrangement advantageously provides many benefits to application users by reducing the time and effort needed to fill out or update user profiles. The savings can be particularly beneficial when a user maintains profiles with multiple different applications. In addition to saving time and effort for the user, the user profile service can pre-populate profile forms with entries that can typically be expected to be highly relevant and well targeted to the user. As a result, the pre-populated profile entries can be more accurate in reflecting the identity and personality of the user compared with manually completed forms which rely on the user's memory. The suggested entries may also help to make the user profile more interesting, compelling, and complete by including information that users might not think of on their own.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative on-line environment that supports various service and application providers, users, and client devices, as well as a user profile population service;

FIG. 2 shows a set of illustrative components that may run on a client device;

FIG. 3 shows a screen shot of a typical user profile as may be displayed by a social networking application on a client device;

FIGS. 4-7 show screen shots of illustrative user profile forms that a user may fill out to initially create a user profile or update a user profile;

FIG. 8 shows an illustrative arrangement for processing individual and aggregated usage data to generate data to pre-populate user profile forms;

FIG. 9 shows illustrative sources of usage data; and

FIG. 10 shows an illustrative arrangement in which a user may accept or reject suggested entries in a user profile form and where the user's actions can be used as feedback to help fine tune or improve the processing employed by the user profile population service.

Like reference numerals indicate like elements in the drawings. Elements are not drawn to scale unless otherwise indicated.

### DETAILED DESCRIPTION

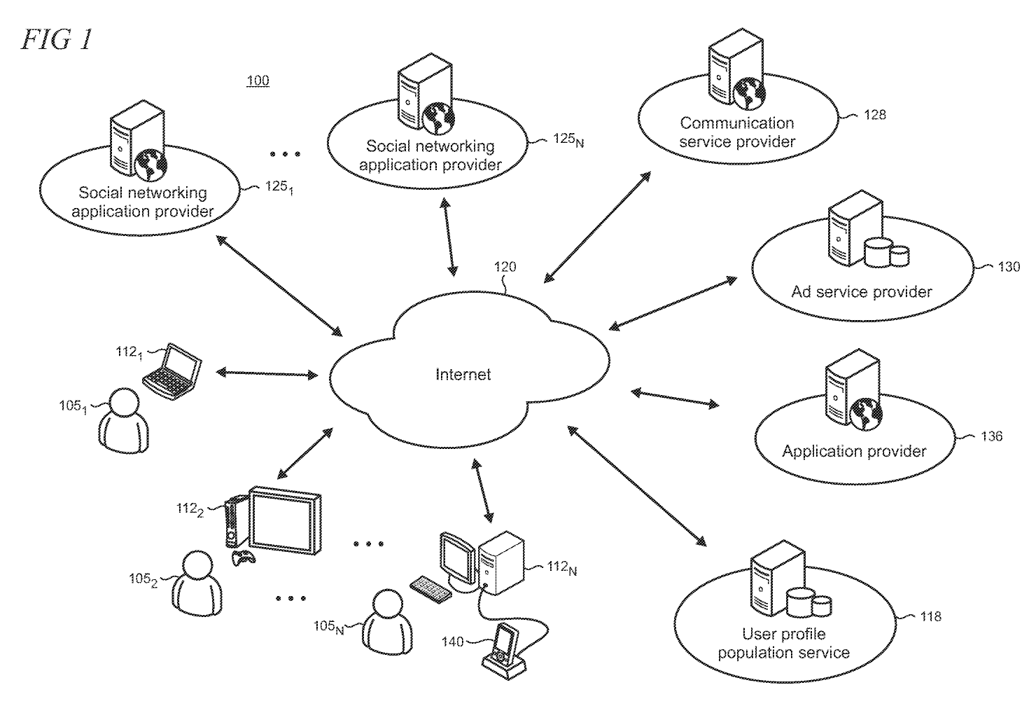

FIG. 1 shows an illustrative on-line environment 100 that supports various service and application providers, users 105_{1,2 . . . N} at respective client devices 112_{1, 2 . . . N}, as well as a user profile population service 118 that are each arranged with connectivity to a public network such as the Internet 120. In this example, the providers include social networking application providers 125_{1 . . . N}, a communication service provider 128 that supports e-mail, instant messaging (“IM”) or other communication service, and an advertisement (“ad”) service provider 130. The social networking application providers 125 support social networking experiences for the users 105, typically using websites that facilitate the creation and updating of user profiles which are utilized as the on-line representation of the user's real world personality. An application provider 136 is also present in the environment 100 which may support one or more applications for a user 105 such as media sharing (like video, audio, or photo sharing), topical forums, games/entertainment, news and information, other web-based experiences, and the like. Although a single application provider 136 is shown in FIG. 1, there could be others that operate in the on-line environment 100 in some implementations.

The ad service provider 130 is an advertising platform that is commonly utilized to enable advertisers to place ads on websites such as search websites. Ads from the ad service provider 130 can often be utilized by a search engine or service and other websites. One example of a commercial implementation is Microsoft Corporation's adCenter. The ad service provider 130 will typically analyze the on-line activity of web users in order to model the users' behavior and make predictions about their intent. This can help provide increased relevance to the ads shown to the users, for example as “sponsored sites” when results are provided in response to a search query, which better promotes the advertiser's interests while enhancing the quality of the user experience. Various algorithms can be used to analyze the on-line activity, based on user actions including search queries, browsing history, and other activities, in ways that preserve user privacy. As described in more detail below, the data collected by the ad service provider 130 may be used in some implementations of the present action-based pre-population of user profiles.

The client devices 112 may comprise, for example, workstations, desktop and laptop PCs, as well as some types of portable devices such as mobile phones, handheld PCs and game devices, and the like that have network interfaces. The client devices 112 may also include a game console 112₂ as well as devices that combine various functionalities of the devices that are shown. A representative example of a peripheral device is also shown in FIG. 1, in this case being a personal media player 140 that can play video and/or audio like the popular MP3 (Moving Pictures Expert Group, MPEG-1, audio layer 3) formatted audio content. Peripheral devices are those that provide some form of functionality but typically include an interface that enables an operative connection or interface to a client device. For example, the personal media player 140 is shown as being connected to the desktop PC 112_{N} as is commonly performed in order to synchronize media content between the player and the PC. Other peripheral devices may include mobile phones, game devices and the like that have interfaces to client devices such as a PC.

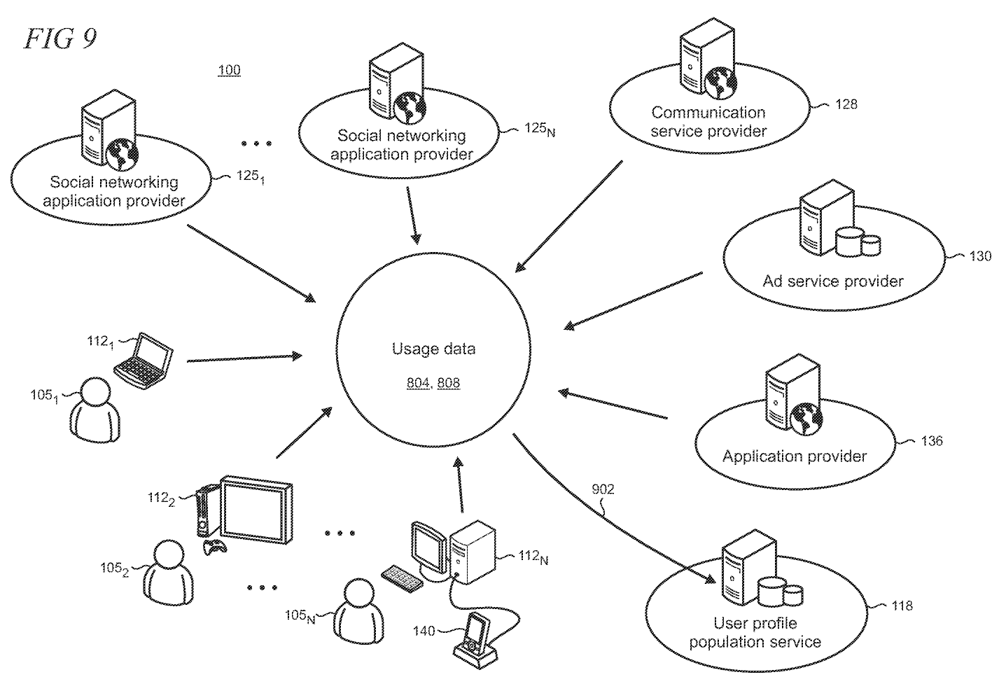

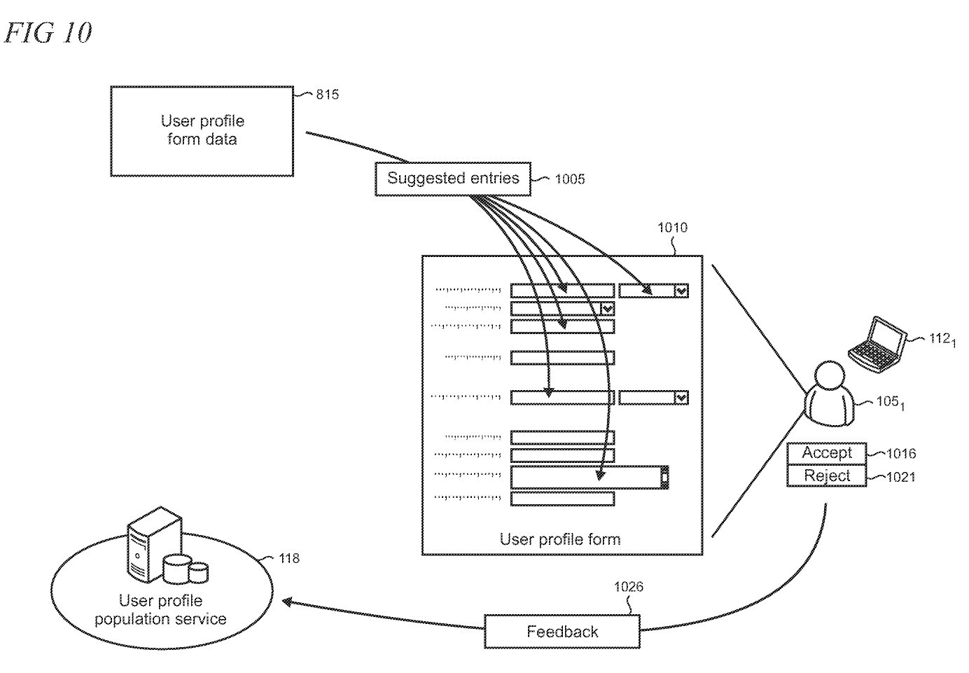

The user profile population service 118 is arranged, in this illustrative example, as a standalone entity that can provide an interface for users to initially set up or update user profiles for one or more of the applications in the environment 100. Typically then, the user profile population service 118 will have a commercial or partnering relationship with the application providers that enables the service to access the forms and then pre-populate suggested entries in them for the users. For example, when the user goes to a website and signs up with an application that needs a user profile, the user will be redirected to the service 118 which then handles the completion of the profile on behalf of the application provider. The user profile population service 118 may alternatively be integrated as a part of an application or service provider. The service 118 is described in more detail in the text accompanying FIGS. 9 and 10.

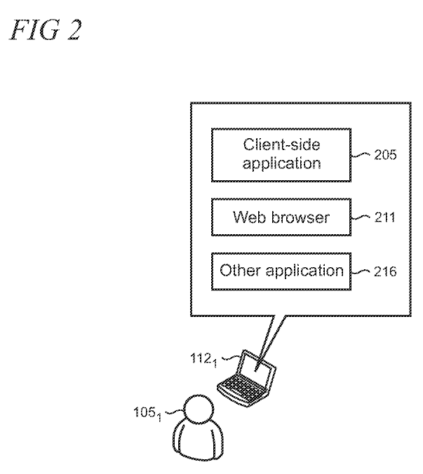

As shown in FIG. 2, the client devices 112 (as represented by laptop 112₁) may host one or more software components including a client-side application 205, web browser 211, or some other application 216. The client-side application will typically provide some functionality that supports some interaction with the application provider 136. For example, a client-side application could be an IM client that interacts with an IM service that is supported by the application provider 136. In other cases, the web browser 211 works as a general purpose client that can support multiple different on-line services or applications. The other application 216 could be arranged as a piece of standalone functionality (i.e., a local application), or be one that is supplemented by or uses data or functionality from an external or on-line source, for example.

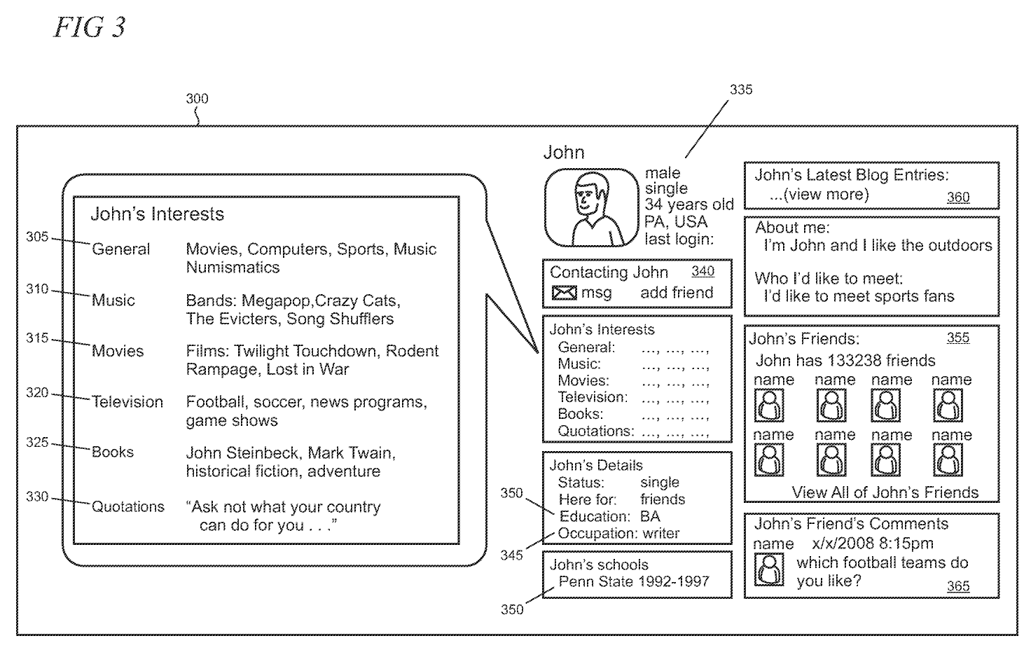

As noted above, the social networking applications from the providers 125 will typically utilize a user profile to represent the on-line personalities of respective social network users. It is emphasized, however, that this social networking example is intended to be illustrative and that the present action-based pre-population of user profiles is not limited to only social networking applications. FIG. 3 shows a typical user profile 300 as may be displayed by a social networking application on a client device, for example by the web browser 211. A user 105 will typically employ the user profile to display tastes and interests, hobbies, friends, viewpoints and opinions, demographic information, education and employment information, personality, prestige and status, etc. (collectively referred to as the user's “on-line personality”) to an audience of friends, colleagues, potential friends and/or love-interests, etc., and/or the web public in general.

More specifically, the illustrative user profile 300 displays various categories of information including general interests 305, music 310, movies 315, television 320, books 325, and quotations 330. Demographic information 335 including gender, age, and location is also shown, as is contact information 340 such as e-mail address. The user profile 300 also displays other information including occupation 345, education 350, friends 355, blogs 360, and comments 365. In some cases, user profiles may also include links to websites and can contain other types of non-written information and content such as pictures and photographs, embedded videos or music, animations, wallpaper, and the like. It is noted that the particular user profile layout used can vary from what is shown in FIG. 3 and can display various types and categories of profile information, but many follow this general type of form.

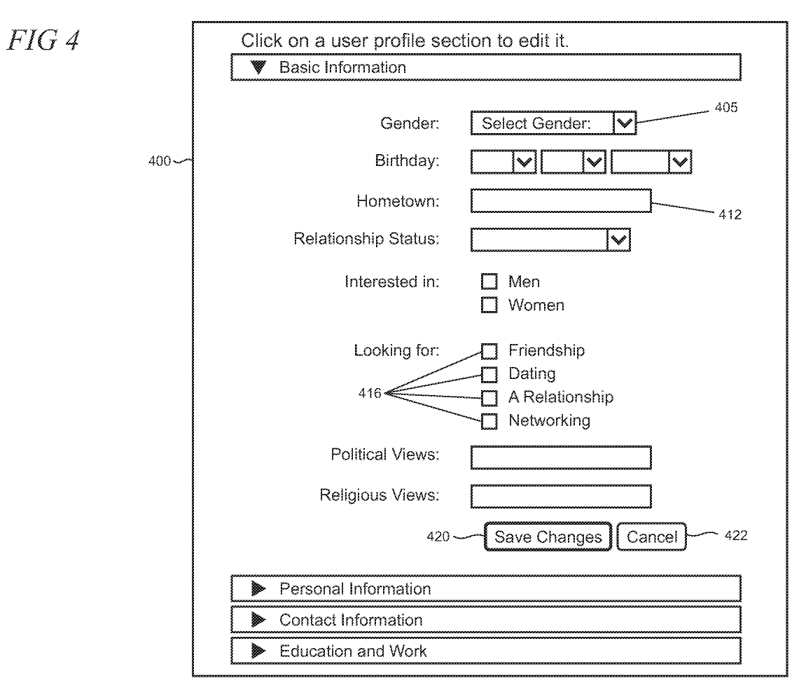

The user profile 300 is typically created through interaction by a user 105 with one or more user profile forms that are supplied by a social networking application provider 125 and displayed, for example, by the web browser 211 (although in alternative implementations, a dedicated client-side application 205 could be used instead of the general purpose web-browser). A set of illustrative user profile forms is shown in FIGS. 4-7. Such forms are typically supported by a social networking application so that users can populate them with entries to reflect their on-line personality.

In user profile form 400 in FIG. 4, basic information is collected from the user 105 who can populate the fields in the form by selecting from drop-down menus, check boxes, fill-in blanks, and the like. For example, the gender drop-down menu 405 includes the entries of “male” and “female” from which the user 105 may make the appropriate selection. The hometown fill-in blank 412 is used to accept an entry from the user 105 to indicate the user's hometown. Checkboxes 416 are used to indicate the kinds of relationships that the user 105 is looking to establish. Once entries are made to complete the basic information to the user's satisfaction, the user 105 can save the entries to the user profile or cancel the entries by pressing the respective button 420 or 422.

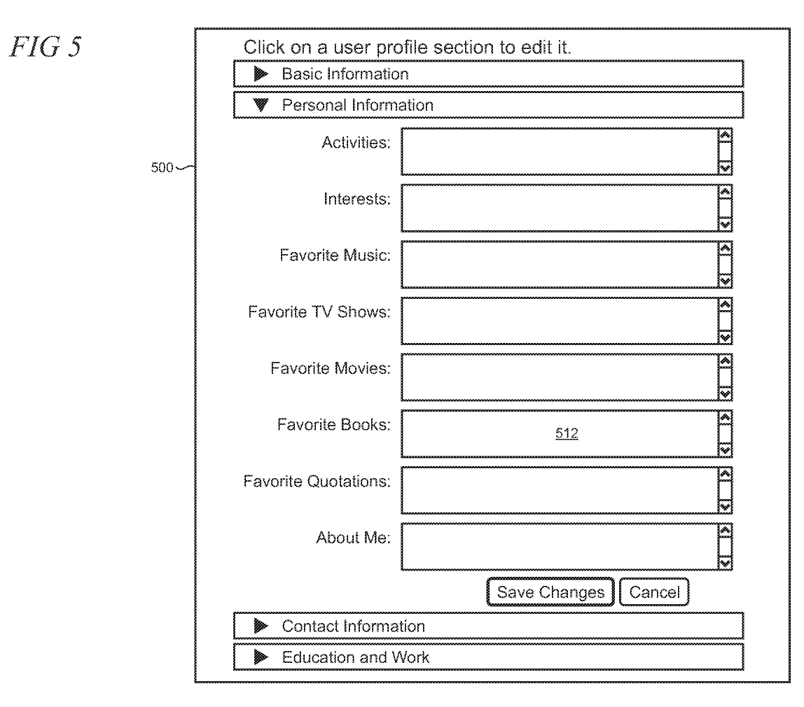

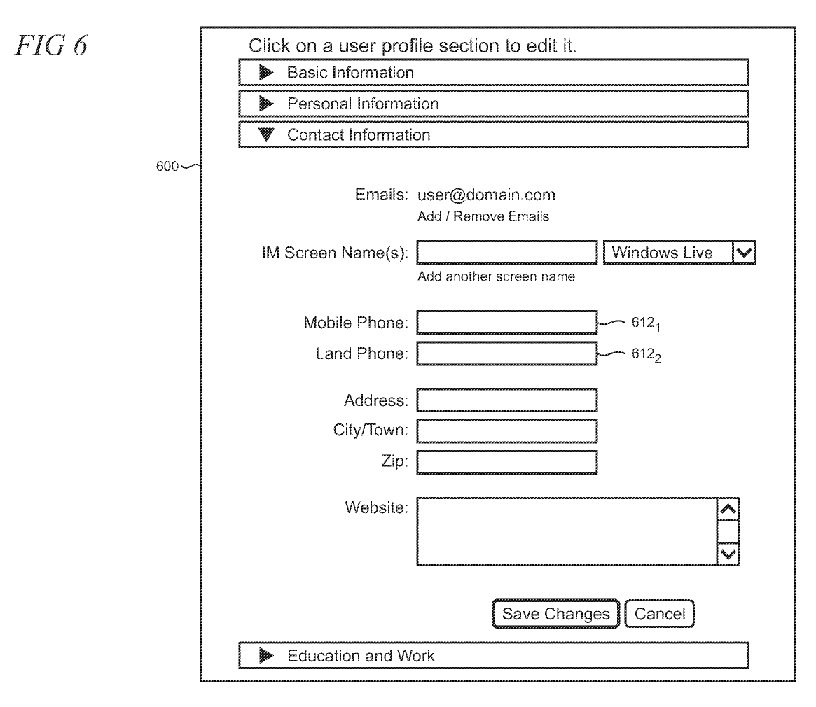

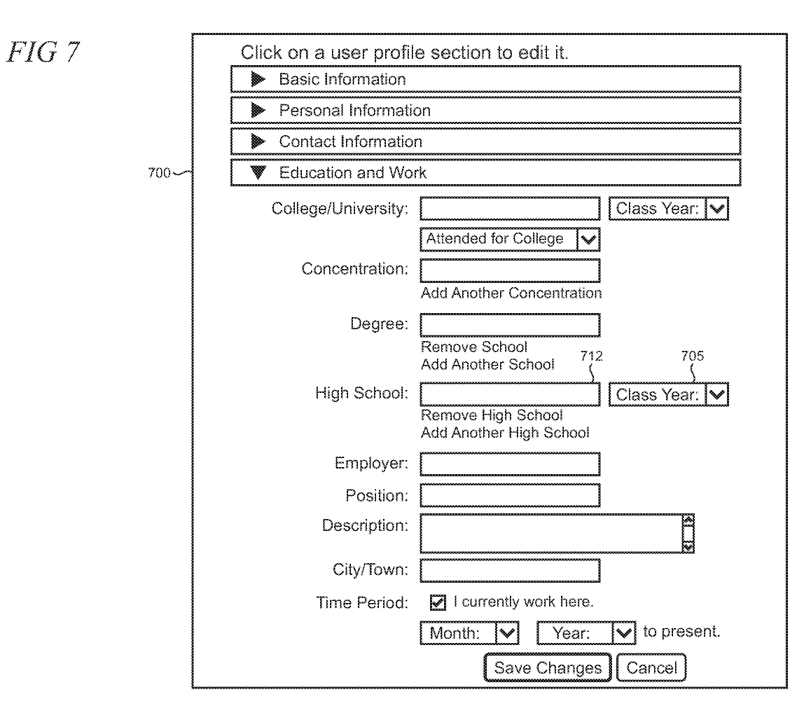

In user profile form 500 in FIG. 5, personal information can be collected when the user 105 makes entries into the various fill-in blanks shown. For example, fill-in blank 512 is used for an entry that describes the user's favorite books or authors. The user 105 may provide entries for various types of contact information in the user profile form 600 shown in FIG. 6 using various fill-in blanks. For example, blanks 612₁ and 612₂ are respectively used for the user's mobile and landline phone numbers. Similarly, the user 105 may provide entries in form 700 in FIG. 7 to indicate work and education information for the user profile. This form uses a mix of fill-in blanks and drop-down menus such as fill-in blank 712 for the user's high school and drop-down menu 705 for the user's class year.

The particular user profile forms utilized in a given implementation can vary from those shown in FIGS. 4-7. However, most forms will generally take some time and effort by the user to manually populate so that the user profiles are complete and accurately reflect the user's personality. Users may find filling out the forms to be burdensome. And in situations where users sign up with multiple social networking application providers 125 (FIG. 1), filling out all the needed user profile forms can be tedious and repetitious to the point where the effort required becomes an obstacle for the user in joining new social networks. But even when users are motivated to fill out the entries in user profile forms, it can still sometimes be difficult for the user to recall all the information needed for the forms. For example, a user might not remember all the book authors they like, or might forget to list some favorite movies.

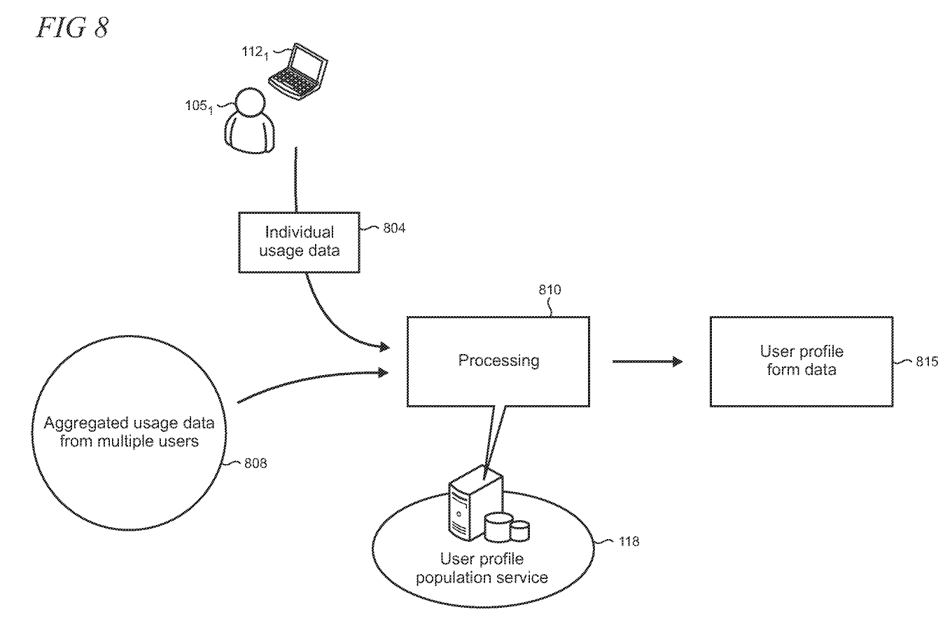

These and other issues may effectively be addressed by the present action-based pre-population of user profile forms where the user profile population service 118 (FIG. 1) generates suggestions that can be pre-populated as entries in the user profile forms. As shown in FIG. 8, the suggested entries are generated by processing usage data that is collected on an individual basis about a specific user 105₁ for whom the suggested user profile entries are provided (individual usage data 804) and usage data that is aggregated from multiple users in the environment and then correlated to provide statistically significant information (aggregated usage data 808) such as characteristics of the users, tendencies, and trends. The term “usage data” as used herein means data that represents user actions when interacting with client and peripheral devices, applications, and services in the environment 100 (FIG. 1). Usage data can be indicative of user behavior, intent, interests, attitudes, and preferences, among other characteristics, and can include any of a variety of data types.

As shown in FIG. 9, the individual usage data 804 may be collected from any of the variety of sources within the on-line environment 100 including the client and peripheral devices (112 and 140) and the application and service providers (125, 128, 130, 136), while the aggregated usage data 808 may be collected from such sources in multiple instances. In an illustrative example, usage data can reflect user actions pertaining to the music that is downloaded from a service and then played on the PC 112₁ and/or the personal media player. The collected usage data might include songs and/or artists that the user has listened to most often, listened to recently, recommended to others, and the like. Usage data collected about the users 105 by the communication service provider 128 can also indicate preferences in music, as well as reflect other information about the users through the personal status messages.

The usage data 804 and 808 is received by the user profile population service 118 as indicated by the arrow 902 in FIG. 9. Typically, the usage data is collected using various automated methods that are exposed through application programming interfaces (“APIs”) that are configured for each of the sources.

Usage data can also be collected to reflect actions of the users 105 with regard to the kinds of websites they visit, the purchases made via e-commerce portals, the blogs they read, etc. Here, the client devices 112 may each run the web browser 211 (FIG. 2) to facilitate interaction with a variety of websites. Various conventional techniques may be used to collect usage data that pertains to website browsing.

In one illustrative example, the ad service provider 130, which is normally configured to collect and analyze a large amount of data dealing with users' interactions with websites, can contribute usage data to the user profile population service 118. Illustratively, the ad service provider 130 can provide usage data that predicts users' age, gender, and other demographic information based on on-line activity such as what search queries are used and the websites that are visited.

The ad service provider 130 may also perform analyses which can determine location (e.g., current and travel destination), detect personal names, categorize content in websites, make predictions as to users' intentions and preferences, and glean other information. In alternative implementations, a search provider (such as Microsoft Live® Search—not shown in FIG. 9) may also be utilized to provide usage data in a similar manner.

The communication service provider 128 may provide usage data that is indicative of user actions when interacting with an IM application. For example, personal status messages are often supported by IM applications that users can employ to indicate if they are ready to instant message with their IM contacts or communicate by voice. Users can typically choose from ready-made messages such as “available” or “busy” or compose their own personal status messages like “at the gym” or “playing golf”. With some IM applications, the personal status message can also be used to show what music a user is listening to on a media player that is running on their client device.

In some cases, usage data pertaining to a particular type of user action can come from either or both devices and providers within the environment 100. For example when the user actions deal with game playing, the game console 112₂ may be configured to track which games are played and the scores achieved when the console is used locally, while the application provider 136 (when arranged as a game application provider) could track game usage and scores when the user 105 participates in multiplayer on-line games. Similarly, if the user actions deal with music playing, then the personal media player 140 can be configured to track the songs and videos that are most frequently played on the player, while the local music synchronization/player software application on the PC 112_{N} could track the music played on the PC, and the application provider 136 (when configured as a music downloading service) tracks the music that is downloaded from the service. The examples of usage data provided above are intended to be illustrative and the types and kinds of usage data that may be utilized in a given implementation are not necessarily limited to only these examples.

It is important to note that the collection of any usage data (including both the individual usage data 804 and the aggregated usage data 808) will typically only be performed upon notice to the user 105 that provides opportunity to agree or decline to participate. Such notice could be included, for example, as a part of the service agreements that are commonly utilized with many on-line applications and services. It can be expected that many users will want to take advantage of the features and benefits provided by the user profile population service 118 and would agree to the collection of the usage data, particularly as the collection can be performed in a manner that is transparent to the user while preserving user privacy.

Referring again to FIG. 8, the aggregated usage data 808 is processed (as indicated by reference numeral 810) by the user profile population service 118 along with individual usage data 804 in order to generate user profile form data 815. The processing 810 used to generate the data 815 comprises, in this example, analysis of the individual usage data 804 for the user 105₁ and correlation of the aggregated usage data 808 which can be compared with the individual usage data.

The analysis of the individual usage data 804 can be expected to identify specific information about the user 105₁ that may be used to pre-populate suggested entries in a user profile form. By comparison, the results of the correlation performed on the aggregated usage data 808 will typically be used to identify tendencies of the user 105₁ and make predictions for additional relevant and appropriate pre-populated entry suggestions. The correlation is performed to identify useful patterns and/or trends in the aggregated usage data through known statistical techniques such as collaborative filtering, which is commonly utilized in the recommendation systems used by on-line bookstores and other e-commerce retailers.

In an illustrative example, individual usage data 804 collected about the user 105₁ from a search service may indicate that the user regularly searches for ski lift tickets. This data is then included in the user profile form data 815 so that the user profile population service 118 can suggest skiing as a pre-populated entry in the user's profile (e.g., as one of the user's interests or hobbies). This individual usage data 804 can also be compared with the aggregated usage data 808 so that the service 118 can generate additional suggestions. So, in this example, correlation of the aggregated usage data 808 may indicate a statistical probability that people who like skiing also like particular movie titles which feature skiing. These titles can thus also be included in the user profile form data 815 and be used as suggested entries in the category of favorite movies in the user profile form 500 in FIG. 5.

Multiple points of comparison can be used between the individual and aggregated usage data when generating suggestions for pre-populated entries. For example, correlation of the aggregated usage data 808 may also show that some users who like skiing, and who also share some common musical interests with the user 105₁ (e.g., by having some of the same favorite artists or genres of music), also like particular televisions shows. These television shows can also be included in the user profile form data 815 and used as suggested entries in the category of favorite shows in the user profile form 500.

The pre-populated suggested entries may be presented to a user both upon initial registering with the application or when a user profile gets updated. For example, the user profile population service 118 can pre-populate the user profile forms shown in FIGS. 4-7 that normally need to be manually completed when signing up with a social networking application. The user profile population service 118 can also provide suggestions for entries when there is need for a user profile to be updated. In such cases, upon notice to the user and with consent, the service 118 may collect individual usage data 804 on a periodic or continuous basis after the initial registration is completed to monitor for changes that could be reflected as an update to the user profile.

The individual usage data could indicate, for example, that the user has developed a new taste for a particular genre of entertainment, changed jobs, or has acquired a new hobby. When this occurs, the user may be prompted with a dialog box that indicates that changes have been detected and the user profile could be updated. The user can then choose to review the suggestions for updated entries. Alternatively, the service 118 could check with the users from time to time to see if the users wish to have their usage data scanned to see if changes have occurred which could be reflected in an updated user profile.

As shown in FIG. 10, the user profile form data 815 is used to create suggested entries 1005 which are pre-populated into a user profile form 1010. The suggested entries could be used in both initial population of a user profile and update scenarios. The pre-populated user profile form 1010 is presented to the user 105₁ (for example by the web browser or client-application), who can accept one or more of the suggestions or reject them, as respectively indicated by reference numerals 1016 and 1021. For example, the user might find that the suggestion is incorrect or does not accurately reflect the user's personality. Or, the suggestion could be correct, but the user still might prefer that the suggestion not be used for some reason.

The acceptances and/or rejections can be supplied back to the user profile population service 118 as feedback 1026 to enable the service to evaluate the accuracy and effectiveness of the processing 810 and make adjustments and improvements as necessary. For example, sensitivity or other analyses can be performed to determine why a particular suggestion may have been rejected by the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An automated method for pre-populating a user profile for an individual user with suggested entries, the method comprising the steps of:
collecting usage data pertaining to the individual user from sources over a network, the sources comprising one or more of on-line applications, local applications, client devices, or peripheral devices, the usage data reflecting user actions with the sources from which characteristics of users are determinable;
aggregating usage data pertaining to a plurality of other users from the sources;
generating the suggested entries using the individual usage data and the aggregated usage data; and
pre-populating the suggested entries into a user profile form for presentation to the individual user.

2. The automated method of claim 1 including a further step of receiving an acceptance or a rejection of one or more of the suggested entries from the individual user.

3. The automated method of claim 2 including a further step of utilizing the received acceptance or rejection as feedback used in the generating.

4. The automated method of claim 1 including a further step of correlating the aggregated usage data to identify statistically significant trends that are usable for making predictions as to characteristics of the individual user.

5. The automated method of claim 4 in which the correlating comprises collaborative filtering.

6. The automated method of claim 4 including the further steps of comparing the individual usage data with the correlated aggregated usage data and generating further suggested entries responsively to the comparing.

7. The automated method of claim 1 including a further step of presenting the pre-populated suggested entries in the user profile form when the individual user initially signs up with an application.

8. The automated method of claim 1 including a further step of presenting the pre-populated suggested entries in the user profile form as an update to an existing user profile.

9. The automated method of claim 1 in which the user profile is associated with a social networking application.

10. The automated method of claim 1 in which the client devices include one of PC or game console and the peripheral devices include one of a mobile phone, game device, or personal media player.

11. The automated method of claim 1 in which the applications include at least one of communication service, social networking, advertising service, web application, website, on-line application, e-commerce, club, forum, or blog.

12. The automated method of claim 1 in which the characteristics include one or more of tastes, interests, hobbies, friends, viewpoints, likes, dislikes, opinions, demographic information, education information, employment information, identity, personality, prestige, or status.

13. A computer-readable medium containing instructions which, when executed by one or more processors disposed in an electronic device, perform a method for operating an on-line application, the method comprising the steps of:
receiving a request from a user to initiate generation of a user profile for the on-line application;
redirecting the request to a user profile population service for handling, the user profile population service being configured for pre-populating suggested entries into fields in a form used for generating a user profile based on individual usage data and aggregated usage data, the suggested entries being displayed to a user for approval or disapproval through a user interface; and
displaying the user profile with user-approved entries.

14. The computer-readable medium of claim 13 including a further step of supporting a dialog box through the user interface to enable the user to consent to the user profile being updated.

15. The computer-readable medium of claim 13 in which the pre-populated suggested entries are generated by comparing the individual usage data with the aggregated usage data, the aggregated usage data being correlated to identify statistically significant tendencies among a plurality of users.

16. A method for updating a user profile of an individual user that is utilized with an on-line application, the method comprising the steps of:
monitoring usage data for the individual user to ascertain if the user profile has changed so that an update to the user profile is performable, the usage data representing user actions with devices and applications from which user characteristics may be derived; and
pre-populating a user profile form with suggested entries for updating the user profile.

17. The method of claim 16 including the further steps of aggregating usage data for a plurality of other users, correlating the aggregated usage data to identify user characteristics, tendencies, or trends, and comparing individual usage data with the aggregated usage data to generate additional suggested entries.

18. The method of claim 17 in which the usage data is provided by one or more sources including client devices, peripheral devices, applications, or services.

19. The method of claim 18 in which the service comprises an advertising service.

20. The method of claim 16 in which the monitoring is performed responsively to consent from the individual user.
